(19) United States
(12) Patent Application Publication
(10) Pub. No.: US 2025/0162558 A1
(43) Pub. Date: May 22, 2025

(54) COIL ASSEMBLY, HYDRAULIC VALVE INCLUDING THE SAME, AND ELECTRIC BRAKE SYSTEM INCLUDING THE SAME

(71) Applicant: HL MANDO CORPORATION, Gyeonggi-do (KR)

(72) Inventors: Heechul JUNG, Gyeonggi-do (KR); Kwanseek KIM, Gyeonggi-do (KR)

(21) Appl. No.: 18/657,700

(22) Filed: May 7, 2024

(30) Foreign Application Priority Data
Nov. 16, 2023 (KR) 10-2023-0159580

(51) Int. Cl. B60T 13/68; B60T 17/18; H01F 7/20; H01F 27/29; H01F 27/32

(52) U.S. Cl. CPC B60T 13/686; B60T 17/18; H01F 7/20; H01F 27/29; H01F 27/325; B60T 2270/402

(57) ABSTRACT

The present disclosure relates to a coil assembly including a bobbin in which an insertion hole is formed in a central portion of the bobbin, a first coil and a second coil which electromagnetically drive an armature and individually separately wound along concentric circles having different diameters on an outer circumferential surface of the bobbin, an insulator which is provided between the first coil and the second coil to electrically insulate the first coil from the second coil, and a coil case spaced a predetermined distance from the second coil and provided to accommodate the first coil and the second coil, a hydraulic valve including the same, and an electric brake system including the same and can secure their stability and reliability even in the failure state of the coils.

### CROSS-REFERENCE TO RELATED APPLICATION

This application claims the benefit of Korean Patent Application No. 10-2023-0159580, filed on Nov. 16, 2023 in the Korean Intellectual Property Office, the disclosure of which is incorporated herein by reference.

### BACKGROUND

### 1. Field

Embodiments of the present disclosure relate to a coil assembly, a hydraulic valve including the same, and an electric brake system including the same.

### 2. Description of the Related Art

In general, a brake system of a vehicle is one of important components directly related to safety. In modern vehicles, electric brake systems are widely used, and these systems can be implemented in various types such as anti-lock brake systems (ABSs), electro-hydraulic brake (EHB) systems, and electronic stability control (ESC) systems. Such an electric brake system generally includes a solenoid valve, a low-pressure accumulator, a pump, a high-pressure accumulator, an electronic control unit (ECU), and the like.

A coil of the solenoid valve serves to generate an electromagnetic field and operate the valve when power is applied thereto. However, in a design so far, since most solenoid valves use single coils, when a problem occurs in a coil, the stability of an electric brake system is seriously degraded. In particular, in autonomous vehicles, such a problem becomes more serious, and it is very important to secure redundancy in a brake system.

Since the conventional solenoid coil design uses a single coil, when a short or open failure occurs in the coil, the operation of an ECU is seriously affected. Accordingly, the stability and reliability of the electric brake system can be seriously degraded.

### SUMMARY

Therefore, it is one aspect of the present disclosure to provide a coil assembly, a hydraulic valve including the same, and an electric brake system including the same.

In accordance with one aspect of the present disclosure, a coil assembly includes a bobbin in which an insertion hole is formed in a central portion of the bobbin, a first coil and a second coil which electromagnetically drive an armature and individually separately wound along concentric circles having different diameters on an outer circumferential surface of the bobbin, an insulator which is provided between the first coil and the second coil to electrically insulate the first coil from the second coil, and a coil case spaced a predetermined distance from the second coil and provided to accommodate the first coil and the second coil.

The coil assembly may further include first coil terminals individually connected to both ends of the first coil and second coil terminals individually connected to both ends of the second coil.

The first coil terminals and the second coil terminals may be symmetrically disposed with respect to the bobbin.

Both ends of the first coil and both ends of the second coil may pass through the coil case and may be provided on top of the coil case, and a first exposed region between both ends of the first coil and the coil case and a second exposed region between both ends of the second coil and the coil case may be provided to be individually accommodated in separate insulators.

The first coil terminals may be electrically connected to a first electronic control unit, and the second coil terminals may be electrically connected to a second electronic control unit.

A diameter of the second coil may be greater than a diameter of the first coil.

The first coil and the second coil may be solenoid coils.

In accordance with another aspect of the present disclosure, a hydraulic valve of an electric brake system, which adjusts a hydraulic brake pressure that is to be transferred to a wheel brake, includes a bobbin in which an insertion hole is formed in a central portion of the bobbin, an armature inserted into the insertion hole to move vertically so as to open or close a flow path, a first coil and a second coil which electromagnetically drive the armature and individually separately wound along concentric circles having different diameters on an outer circumferential surface of the bobbin, an insulator which is provided between the first coil and the second coil to electrically insulate the first coil from the second coil, and a coil case spaced a predetermined distance from the second coil and provided to accommodate the first coil and the second coil.

The hydraulic valve may further include first coil terminals individually connected to both ends of the first coil and second coil terminals individually connected to both ends of the second coil.

The first coil terminals and the second coil terminals may be symmetrically disposed with respect to the bobbin.

Both ends of the first coil and both ends of the second coil may pass through the coil case and may be provided on top of the coil case, and a first exposed region between both ends of the first coil and the coil case and a second exposed region between both ends of the second coil and the coil case may be provided to be individually accommodated in separate insulators.

The first coil terminals may be electrically connected to a first electronic control unit, and the second coil terminals may be electrically connected to a second electronic control unit.

A diameter of the second coil may be greater than a diameter of the first coil.

The first coil and the second coil may be solenoid coils.

In accordance with still another aspect of the present disclosure, an electric brake system, which adjusts a hydraulic brake pressure that is to be transferred to a wheel brake, includes a hydraulic valve including a bobbin in which an insertion hole is formed in a central portion of the bobbin, an armature inserted into the insertion hole to move vertically so as to open or close a flow path, a first coil and a second coil which electromagnetically operate the armature and individually separately wound along concentric circles having different diameters on an outer circumferential surface of the bobbin, an insulator which is provided between the first coil and the second coil to electrically insulate the first coil from the second coil, a coil case spaced a predetermined distance from the second coil and provided to accommodate the first coil and the second coil, first coil terminals individually connected to both ends of the first coil, and second coil terminals individually connected to both ends of the second coil, a first electronic control unit which is electrically connected to the first coil terminals and controls the hydraulic valve, and a second electronic control unit which is electrically connected to the second coil terminals and controls the hydraulic valve.

When both the first coil and the second coil are in normal states, the first electronic control unit may control the hydraulic valve.

When the first coil fails, the second electronic control unit may control the hydraulic valve, and when the second coil fails, the first electronic control unit may control the hydraulic valve.

When the first electronic control unit fails, the second electronic control unit may control the hydraulic valve, and when the second electronic control unit fails, the first electronic control unit may control the hydraulic valve.

Both ends of the first coil and both ends of the second coil may pass through the coil case and may be provided on top of the coil case, and a first exposed region between both ends of the first coil and the coil case and a second exposed region between both ends of the second coil and the coil case may be provided to be individually accommodated in separate insulators.

The first coil terminals and the second coil terminals may be symmetrically disposed with respect to the bobbin.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view illustrating a structure of a coil assembly according to one embodiment;

FIG. 2 is a plan view illustrating the coil assembly according to one embodiment; and

FIG. 3 is a view illustrating a configuration of an electric brake system according to one embodiment.

### DETAILED DESCRIPTION

Like reference numerals denote like elements throughout the specification. In the present specification, all elements of embodiments are not described, and general contents in the art or repeated contents between the embodiments will not be described. Terms such as “parts, modules, members, and blocks” can be implemented using software or hardware, and a plurality of parts, modules, members, and blocks may be implemented as a single component, or one part, module, member, or block may also include a plurality of components.

Throughout the specification, when a first portion is referred to as being “connected” to a second portion, it includes “directly connected” to the second portion and “indirectly connected” to the second portion, and the “indirectly connected” to the second portion includes “connected” to the second portion through a wireless communication network.

In addition, when a certain portion “includes” a certain component, this does not exclude other components unless explicitly described otherwise, and other components may be further included.

Throughout the specification, when a first member is referred to as being positioned “on” a second member, the first member is in contact with the second member, or a third member is interposed between the first and second members.

Terms such as first, second, and the like are used herein to distinguish a first component from a second component, and the first and second components are not limited to the above-described terms.

As used herein, singular forms are intended to include the plural forms as well, unless the context clearly indicates otherwise.

Reference numerals in operations are used for the sake of convenience in description and do not describe an order of the operations, and the operations may be performed through an order different from the described order unless the context clearly indicates a specific order.

Hereinafter, operational principles and embodiments of the disclosure will be described with reference to the accompanying drawings.

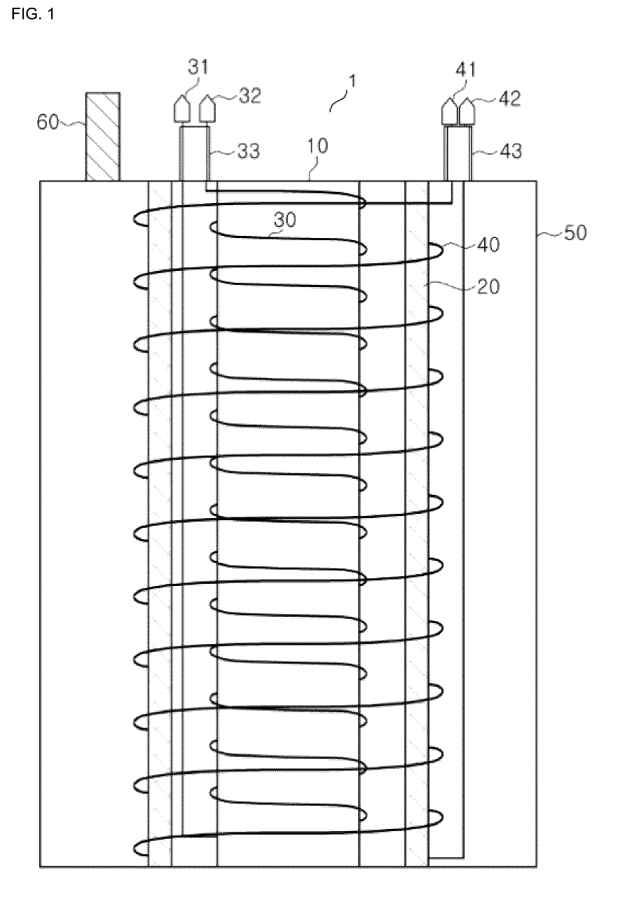

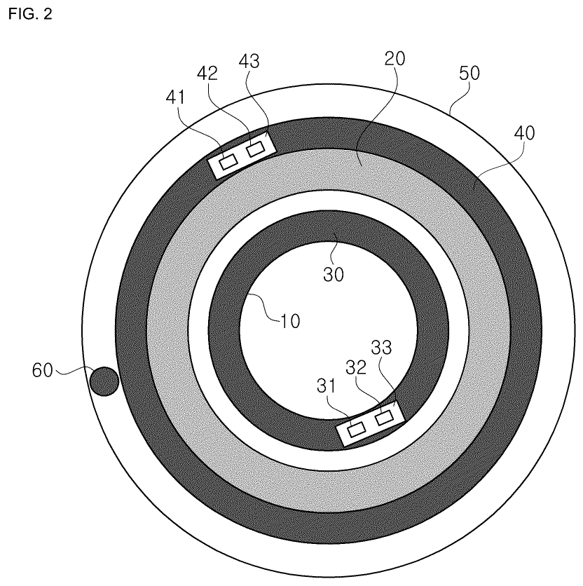

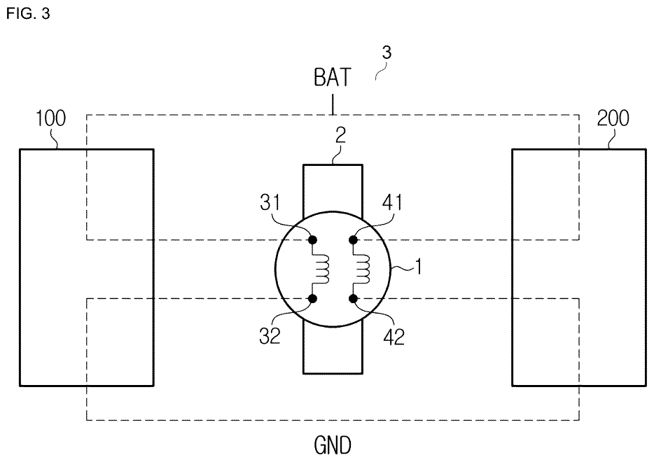

FIG. 1 is a cross-sectional view illustrating a structure of a coil assembly 1 according to one embodiment, FIG. 2 is a plan view illustrating the coil assembly 1 according to one embodiment, and FIG. 3 is a view illustrating a configuration of an electric brake system 3 according to one embodiment.

Referring to FIGS. 1 and 2, the coil assembly 1 according to the embodiment of the present disclosure may include a bobbin 10, a first coil 30, a second coil 40, an insulator 20, a coil case 50, and a fixing pin 60 and have a cylindrical shape.

An insertion hole through which an armature (not shown) moves vertically may be formed in the bobbin 10 in a central portion of the coil assembly 1.

The first coil 30 and the second coil 40 may electromagnetically operate the armature and may be individually separately wound along concentric circles having different diameters on an outer circumferential surface of the bobbin 10. In this case, the diameter of the second coil 40 may be greater than the diameter of the first coil 30. That is, the second coil 40 is wound outside the first coil 30. In this case, the insulator 20 for electrical insulation between the first coil 30 and the second coil 40 may be provided therebetween.

In one embodiment, the first coil 30 and the second coil 40 may be solenoid coils.

First coil terminals 31 and 32 may be connected to both ends of the first coil 30. In the same manner, second coil terminals 41 and 42 may be connected to both ends of the second coil 40.

In this case, both ends of the first coil 30 and both ends of the second coil 40 may be provided to pass through the coil case 50 and protrude upward from the coil case 50.

Both ends of the first coil 30 may be located adjacent to each other, and both ends of the second coil 40 may also be located adjacent to each other.

In this case, a first exposed region may be a portion which is disposed between both ends of the first coil 30 and the coil case 50 and through which the first coil 30 is exposed and may be provided to be accommodated in a separate insulator 33.

In a manner like that of the first coil 30, a second exposed region may be a portion which is disposed between both ends of the second coil 40 and the coil case 50 and through which the second coil 40 is exposed and may be provided to be accommodated in another separate insulator 43.

In one embodiment, both ends of the first coil 30 and both ends of the second coil 40 may be symmetrically disposed with respect to the bobbin 10. However, the present disclosure is not limited thereto, and various types of arrangement structures may be applied.

The insulator 20 may be provided between the first coil 30 and the second coil 40 to electrically insulate the first coil 30 from the second coil 40.

The first coil terminals 31 and 32 may be electrically connected to a first electronic control unit or controller 100, and the second coil terminals 41 and 42 may be electrically connected to a second electronic control unit or controller 200.

The coil case 50 may be spaced a predetermined distance from the second coil 40 and provided to accommodate the first coil 30 and the second coil 40.

One end of the fixing pin 60 may be located between an outer circumferential surface of the second coil 40 and an inner circumferential surface of the coil case 50 and provided to pass through the coil case 50 so that the other end protrudes upward from the coil case 50. The fixing pin 60 may have a cylindrical shape. The fixing pin 60 may serve to stably couple the coil assembly 1 and a valve assembly (not shown) to constitute one hydraulic valve 2.

The hydraulic valve 2 may include the bobbin 10 in which the insertion hole is provided in a central portion of the bobbin 10, the armature inserted into the insertion hole to vertically move so as to open or close a flow path, the first coil 30 and the second coil 40 which electromagnetically drive the armature and are individually separately wound along concentric circles having different diameters on the outer circumferential surface of the bobbin 10, the insulator 20 which is provided between the first coil 30 and the second coil 40 to electrically insulate the first coil 30 from the second coil 40, and the coil case 50 spaced the predetermined distance from the second coil 40 and provided to accommodate the first coil 30 and the second coil 40.

Both ends of the first coil 30 and both ends of the second coil 40 may pass through the coil case 50 and be provided on top of the coil case 50.

The first coil terminals 31 and 32 may be connected to both ends of the first coil 30, and the second coil terminals 41 and 42 may be connected to both ends of the second coil 40.

The first coil terminals 31 and 32 may be electrically connected to the first electronic control unit 100, and the second coil terminals 41 and 42 may be electrically connected to the second electronic control unit 200.

In one embodiment, the first coil terminals 31 and 32 and the second coil terminals 41 and 42 may be symmetrically disposed with respect to the bobbin 10. However, the present disclosure is not limited thereto, and various types of arrangement structures may be applied.

Both ends of the first coil 30 may be located adjacent to each other, and both ends of the second coil 40 may also be located adjacent to each other.

The first exposed region between both ends of the first coil 30 and the coil case 50 and the second exposed region between both ends of the second coil 40 and the coil case 50 may be provided to be accommodated in the separate insulators 33 and 43.

That is, the first exposed region may be the portion in which the first coil 30 is exposed between both ends of the first coil 30 and the coil case 50 and may be provided to be accommodated in the separate insulator 33. In a manner like that of the first coil 30, the second exposed region may be the portion which the second coil 40 is exposed between both ends of the second coil 40 and the coil case 50, and may be provided to be accommodated in the another separate insulator 43.

According to one embodiment, the first coil 30 and the second coil 40 may be the solenoid coils, and accordingly, the hydraulic valve 2 may also be a solenoid valve.

One end of the fixing pin 60 may be located between the outer circumferential surface of the second coil 40 and the inner circumferential surface of the coil case 50 and provided to pass through the coil case 50 so that the other end protrudes upward from the coil case 50. The fixing pin 60 may have the cylindrical shape. The fixing pin 60 may serve to stably couple the coil assembly 1 and the valve assembly (not shown) to constitute one hydraulic valve 2.

Referring to FIG. 3, the electric brake system 3 which adjusts a hydraulic brake pressure that is to be transferred to a wheel brake may include the hydraulic valve 2 and the first electronic control unit 100 and the second electronic control unit 200 which control the hydraulic valve 2.

In this case, the hydraulic valve 2 is the hydraulic valve 2 described with reference to FIGS. 1 and 2.

The first electronic control unit 100 and the second electronic control unit 200 may be electrically connected to the first coil terminals 31 and 32 and the second coil terminals 41 and 42 in the hydraulic valve 2 and may apply control signals thereto to control the hydraulic valve 2.

That is, since a double winding coil is applied in the hydraulic valve 2, unlike the conventional electric brake system to which a single winding coil is applied, a redundancy can be provided to the coil in the valve. Accordingly, even when an abnormal situation such as a short circuit or an open circuit occurs in any one coil of two coils, an electronic control unit connected to the other coil may control the hydraulic valve 2 to provide stability and reliability to the system.

When both the first coil 30 and the second coil 40 are in normal states, the electric brake system 3 may be configured to control the hydraulic valve 2 using the first electronic control unit 100. That is, in a normal state, the first electronic control unit 100 may control the hydraulic valve 2 as a main control unit.

When the first coil 30 fails, the second electronic control unit 200 may control the hydraulic valve 2.

Conversely, when the second coil 40 fails, the first electronic control unit 100 may control the hydraulic valve 2.

When the first electronic control unit 100 fails in a state in which both the first coil 30 and the second coil 40 are normal, the second electronic control unit 200 may control the hydraulic valve 2.

Similarly, when the second electronic control unit 200 fails, the first electronic control unit 100 may control the hydraulic valve 2.

Each of the first electronic control unit 100 and the second electronic control unit 200 may include a processor and a memory.

The first electronic control unit 100 and the second electronic control unit 200 may be integrally or separately disposed on one or two printed circuit boards (PCBs). In addition, when the first electronic control unit 100 and the second electronic control unit 200 are separately disposed on two PCBs, the electronic control unit 100 and the second electronic control unit 200 may be separately inserted into two housings. When the first electronic control unit 100 and the second electronic control unit 200 are integrally disposed on one PCB, the first electronic control unit 100 and the second electronic control unit 200 may be inserted into one housing.

In addition, each processor may include a micro control unit. The micro control unit of each of the first electronic control unit 100 and the second electronic control unit 200 may generate a brake signal. The brake signal applied from the micro control unit may be transmitted to each of the first coil 30 and the second coil 40 provided in the coil assembly 1.

That is, the first electronic control unit 100 and the second electronic control unit 200 may apply the brake signals to the first coil 30 and the second coil 40 to control the operation of the hydraulic valve 2. Accordingly, the armature may vertically move in the insertion hole to open or close the flow path.

For example, when the brake signals of the first electronic control unit 100 and/or the second electronic control unit 200 are applied to the first coil 30 and/or the second coil 40, the flow path in the hydraulic valve 2 is opened. As the hydraulic brake pressure acts due to a brake fluid introduced through the open flow path, a brake operates.

According to one aspect of the present disclosure, a coil assembly that can operate normally even in a failure situation such as a short or open failure of a coil in a valve, a hydraulic valve including the same, and an electric brake system including the same can be provided.

Accordingly, the coil assembly, the hydraulic valve including the same, and the electric brake system including the same can secure their stability and reliability even in the failure state of the coil.

The above description is only an example describing the technical spirit of the present disclosure, and various changes, modifications, and replacements may be made by those skilled in the art without departing from the essential characteristics of the present disclosure. Therefore, the embodiments disclosed in the present disclosure are considered in a descriptive sense only and not for purposes of limitation, and the scope of the disclosure is not limited by the embodiments. It should be interpreted that the scope of the disclosure is defined by the appended claims and encompasses all modifications and equivalents that fall within the scope of the appended claims.

What is claimed is:

1. A coil assembly comprising:
a bobbin having a hole at a center portion of the bobbin;
a first coil and a second coil configured to electromagnetically drive an armature, wherein the first coil and the second coil are each separately and coaxially wound around the bobbin such that a first diameter, around which the first coil is wound, and a second diameter, around which the second coil is wound, are different from each other;
an insulator disposed between the first coil and the second coil to electrically insulate between the first coil and the second coil; and
a coil case spaced apart from the second coil and accommodating the first coil and the second coil in the coil case.

2. The coil assembly of claim 1, further comprising:
first coil terminals connected to ends of the first coil, respectively; and
second coil terminals connected to ends of the second coil, respectively.

3. The coil assembly of claim 2, wherein the first coil terminals and the second coil terminals are symmetrically disposed with respect to the bobbin.

4. The coil assembly of claim 2, wherein:
the ends of the first coil and the ends of the second coil pass through the coil case to be extended to an outside of the coil case; and
the coil assembly comprises a first insulator covering a first exposed portion of the first coil between the ends of the first coil and the coil case and a second insulator covering a second exposed portion of the second coil between the ends of the second coil and the coil case, wherein the first insulator and the second insulator are separated from each other.

5. The coil assembly of claim 2, wherein:
the first coil terminals are configured to be electrically connected to a first electronic controller; and
the second coil terminals are configured to be electrically connected to a second electronic controller.

6. The coil assembly of claim 2, wherein the second diameter, around which the second coil is wound, is greater than the first diameter, around which the first coil is wound.

7. The coil assembly of claim 1, wherein the first coil and the second coil are solenoid coils.

8. A hydraulic valve of an electric brake system configured to adjust a hydraulic brake pressure to be transferred to a wheel brake, the hydraulic valve comprising:
a bobbin having an insertion hole at a center portion of the bobbin;
an armature movably disposed in the insertion hole of the bobbin to open or close a flow path;
a first coil and a second coil configured to electromagnetically drive the armature, wherein the first coil and the second coil are each separately and coaxially wound around the bobbin such that a first diameter, around which the first coil is wound, and a second diameter, around which the second coil is wound, are different from each other;
an insulator disposed between the first coil and the second coil to electrically insulate between the first coil and the second coil; and
a coil case spaced apart from the second coil and accommodating the first coil and the second coil in the coil case.

9. The hydraulic valve of claim 8, further comprising:
first coil terminals connected to ends of the first coil, respectively; and
second coil terminals connected to ends of the second coil, respectively.

10. The hydraulic valve of claim 9, wherein the first coil terminals and the second coil terminals are symmetrically disposed with respect to the bobbin.

11. The hydraulic valve of claim 9, wherein:
the ends of the first coil and the ends of the second coil pass through the coil case to be extended to an outside of the coil case; and
the coil assembly comprises a first insulator covering a first exposed portion of the first coil between the ends of the first coil and the coil case and a second insulator covering a second exposed portion of the second coil between the ends of the second coil and the coil case, wherein the first insulator and the second insulator are separated from each other.

12. The hydraulic valve of claim 9, wherein:
the first coil terminals are configured to be electrically connected to a first electronic controller; and
the second coil terminals are configured to be electrically connected to a second electronic controller.

13. The hydraulic valve of claim 8, wherein the second diameter, around which the second coil is wound, is greater than the first diameter, around which the first coil is wound.

14. The hydraulic valve of claim 8, wherein the first coil and the second coil are solenoid coils.

15. An electric brake system configured to adjust a hydraulic brake pressure to be transferred to a wheel brake, the electric brake system comprising:
a hydraulic valve including a bobbin having an insertion hole at a center portion of the bobbin, an armature movably disposed in the insertion hole of the bobbin to open or close a flow path, a first coil and a second coil configured to electromagnetically drive the armature, wherein the first coil and the second coil are each separately and coaxially wound around the bobbin such that a first diameter, around which the first coil is wound, and a second diameter, around which the second coil is wound, are different from each other, an insulator disposed between the first coil and the second coil to electrically insulate between the first coil and the second coil, a coil case spaced apart from the second coil and accommodating the first coil and the second coil in the coil case, first coil terminals connected to ends of the first coil, respectively, and second coil terminals connected to ends of the second coil, respectively;
a first electronic controller electrically connected to the first coil terminals; and
a second electronic controller electrically connected to the second coil terminals.

16. The electric brake system of claim 15, wherein the first electronic controller is configured to, when both the first coil and the second coil are in normal states, control the hydraulic valve.

17. The electric brake system of claim 15, wherein:
the second electronic controller is configured to, in response to failure of the first coil, control the hydraulic valve; and
the first electronic controller is configured to, in response to failure of the second coil, control the hydraulic valve.

18. The electric brake system of claim 16, wherein:
the second electronic controller is configured to, in response to failure of the first electronic controller, control the hydraulic valve; and
the first electronic controller is configured to, in response to failure of the second electronic controller, control the hydraulic valve.

19. The electric brake system of claim 15, wherein:
the ends of the first coil and the ends of the second coil pass through the coil case to be extended to an outside of the coil case; and
the coil assembly comprises a first insulator covering a first exposed portion of the first coil between the ends of the first coil and the coil case and a second insulator covering a second exposed portion of the second coil between the ends of the second coil and the coil case, wherein the first insulator and the second insulator are separated from each other.

20. The electric brake system of claim 15, wherein the first coil terminals and the second coil terminals are symmetrically disposed with respect to the bobbin.
